(19) United States
(12) Patent Application Publication
(10) Pub. No.: US 2006/0110561 A1
(43) Pub. Date: May 25, 2006

(54) Label structure and label structure obtaining method

(76) Inventor: Jeffrey Arippol, Sao Paulo (BR)

Correspondence Address: STATTLER JOHANSEN & ADELI, P O BOX 51860, PALO ALTO, CA, 94303, US

(21) Appl. No.: 11/201,022

(22) Filed: Aug. 9, 2005

(30) Foreign Application Priority Data
Nov. 25, 2004 (BR) PI 0405249-8
May 18, 2005 (BR) CI 0405249-8

(51) Int. Cl. B32B 33/00

(52) U.S. Cl. 428/40.1

(57) ABSTRACT

This invention is related to a label structure including a paper or silicone-coated plastic label body (1) provided, in the front surface, with a printing layer (2) and, on the back surface, with silicone layer and end cross gluing surfaces (3); self-adhesive inner labels (10), formed by paper, self-adhesive plastic label body, or other similar compound material (11), the front surface of which is provided with a printing layer (12) and the back surface with a pressure-sensitive adhesive layer (13); the back surface of the silicone-coated label body (1) being provided with regions of silicone layers (4) arranged in accordance with the self-adhesive inner labels (10) and of bands (5), (5′) and (5″) around said silicone layer regions (4), in which the silicone was removed or inhibited; the back surface of the silicone-coated label body (1) being covered by a paper or self-adhesive plastic body (10′) provided, in the surface opposite to that facing the silicone-coated label body (1), with the printing layer (12) and in the surface facing the silicone-coated label body (1), with a pressure-sensitive adhesive layer (13); said self adhesive body (10′) being also provided with cuts (14), which define the shapes of the inner labels (10) and of the bands around them (15), (15′) and (15″); said inner labels (10) being glued so as to be unglued over the respective silicone layer regions (4) and the bands (15), (15′) and (15″) being permanently glued over, respectively, the bands (5), (5′) and (5″) without silicone or with inhibited silicone.

### CROSS REFERENCE TO RELATED APPLICATIONS

This patent application claims the benefit of Brazilian Patent Application No. PI 0405249-8, of Nov. 25, 2004, and entitled “IMPROVEMENTS IN LABEL AND IN THE LABEL OBTAINING METHOD,” and Brazilian Invention Addition Certificate No. C1 0405249-8, of May 18, 2005, and entitled “IMPROVED LABEL AND LABEL OBTAINING METHOD,” which are both incorporated by reference in their entirety herein.

### BACKGROUND

1. Field of the Invention

The present invention relates generally to manufacturing technologies and, more specifically, to an improved label structure and a method for obtaining such label structure.

2. Background

Labels comprised essentially of the following are already known: a label body, the surface of which is turned inward, which has a printing layer comprising the label itself and the surface turned inwards, and has adhered thereto label(s) containing gift(s), coupon(s) or similar products, which may be accessed and used according to their characteristics by the final user of the product with such label affixed.

Notwithstanding such kind of label being proper for its intended purposes, in certain applications, it would be advantageous to provide a better confinement of the labels containing gifts, coupon or others when the label is applied, thus avoiding an attempt of undue access thereto. It would also be advantageous to provide a continuous surface throughout the back area of the label body, comprised of the labels and a frame surrounding the labels, which avoids the creation of occasional marking of the label edges on the outer surface of the label body or avoids the formation of interstitial between the upper and lower edges of the label body and the surface of the receiving package, which facilitate the undue access to the labels or the penetration and accumulation of dirt or other aggressive agents or that facilitates said upper and lower edges of the label body to get caught inadvertently in any other surface and tear up the label body.

### SUMMARY

This invention is related to a label structure including a paper or silicone-coated plastic label body (1) provided, in the front surface, with a printing layer (2) and, on the back surface, with silicone layer and end cross gluing surfaces (3); self-adhesive inner labels (10), formed by paper, self-adhesive plastic label body, or other similar compound material (11), the front surface of which is provided with a printing layer (12) and the back surface with a pressure-sensitive adhesive layer (13); the back surface of the silicone-coated label body (1) being provided with regions of silicone layers (4) arranged in accordance with the self-adhesive inner labels (10) and of bands (5), (5′) and (5″) around said silicone layer regions (4), in which the silicone was removed or inhibited; the back surface of the silicone-coated label body (1) being covered by a paper or self-adhesive plastic body (10′) provided, in the surface opposite to that facing the silicone-coated label body (1), with the printing layer (12) and in the surface facing the silicone-coated label body (1), with a pressure-sensitive adhesive layer (13); said self adhesive body (10′) being also provided with cuts (14), which define the shapes of the inner labels (10) and of the bands around them (15), (15′) and (15″); said inner labels (10) being glued so as to be unglued over the respective silicone layer regions (4) and the bands (15), (15′) and (15″) being permanently glued over, respectively, the bands (5), (5′) and (5″) without silicone or with inhibited silicone and is also presented a method to obtain the label structure.

### BRIEF DESCRIPTION OF THE DRAWINGS

FIG. 1 illustrates a perspective view of a label structure having a silicone-coated label body and a self-adhesive body, according to one embodiment of the invention;

FIG. 2 illustrates a perspective view of the label front, when applied to a package, according to one embodiment of the invention;

FIG. 3 illustrates a perspective view of the label structure from the opposite side, with a partial sectional view of the label structure, according to one embodiment of the invention;

FIG. 4 illustrates a sectional view of the label structure, with the silicone-coated label body separated from the self-adhesive body, which contains the labels, according to one embodiment of the invention;

FIG. 5 illustrates another sectional view of the label structure, with the silicone-coated label body separated from the self-adhesive body, according to one embodiment of the invention;

FIGS. 6 and 7 illustrate the label structure applied on a package and being taken off the package for access to its internal labels, respectively, according to one embodiment of the invention;

FIG. 8 illustrates a scheme of the label structure obtaining method, according to one embodiment of the invention.

### DETAILED DESCRIPTION

As described in detail below and as illustrated in the figures, the label structure subject to this invention is of a type comprised essentially: of a label body with length slightly longer than the perimeter of the receiver package that, when applied, surrounds the whole package and its ends receive glue at the time of the application and remain superposed, a first end being glued on the package and the other on the first; and of self-adhesive label(s) containing gift(s), coupon(s) or similar products originally glued on the back face of the label body, and which may be accessed when it is torn. In the following description, label and label structures are used interchangeably and refer to the same structure subject of the present invention.

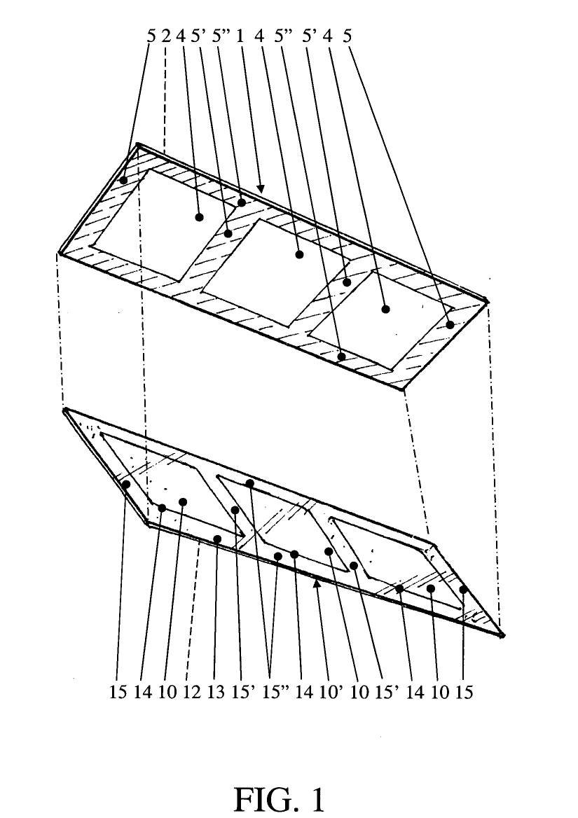

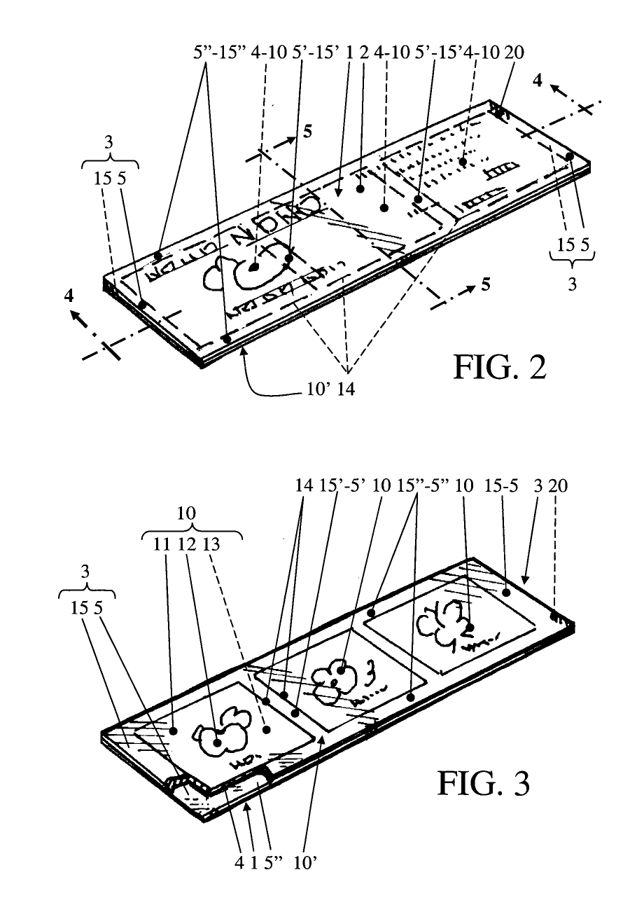

As illustrated in FIGS. 1 and 2, in one embodiment, the label structure is comprised: of a paper or silicone-coated plastic label body 1 provided, in the front face, of a printing layer 2, comprised the label itself; and, on the back face, of silicone layer and end cross gluing surfaces 3, in which the silicone was extracted by sandpapering, so as that those ends may receive and keep the glue applied thereon at the label application time; said label structure is also comprised of self-adhesive inner labels 10, formed by paper or self-adhesive plastic label body 11, the front face of which is provided with a printing layer 12, which configures the label itself and, in the back face, said self-adhesive body 11 is provided with a pressure-sensitive adhesive layer 13, which is originally glued so as to be unglued from the back silicone layer of the silicone-coated label body 1.

The present invention aims at providing a label structure of the type above, the bands of which around the labels 10 are covered, in order to allow better confinement of the labels 10 when the product label is applied on the package and other advantages. For such purpose, in one embodiment, instead of the silicone-coated label body 1 having the back face fully covered with silicone, excepting in the gluing cross end surfaces 3, said label structure has the back surface of the silicone-coated label body 1 provided with regions of silicone layers 4 arranged in accordance with the self-adhesive inner labels 10, and with bands around said silicone layer regions 4, in which the silicone was removed or inhibited, to wit: two end cross bands 5, defined between the end silicone layer regions 4 and the cross edges of the silicone label body 1; intermediate cross band(s) 5′, defined between the silicone layer regions 4 and two longitudinal bands 5″, defined between the silicone layer regions 4 and the longitudinal edges of the silicone-coated label body 1.

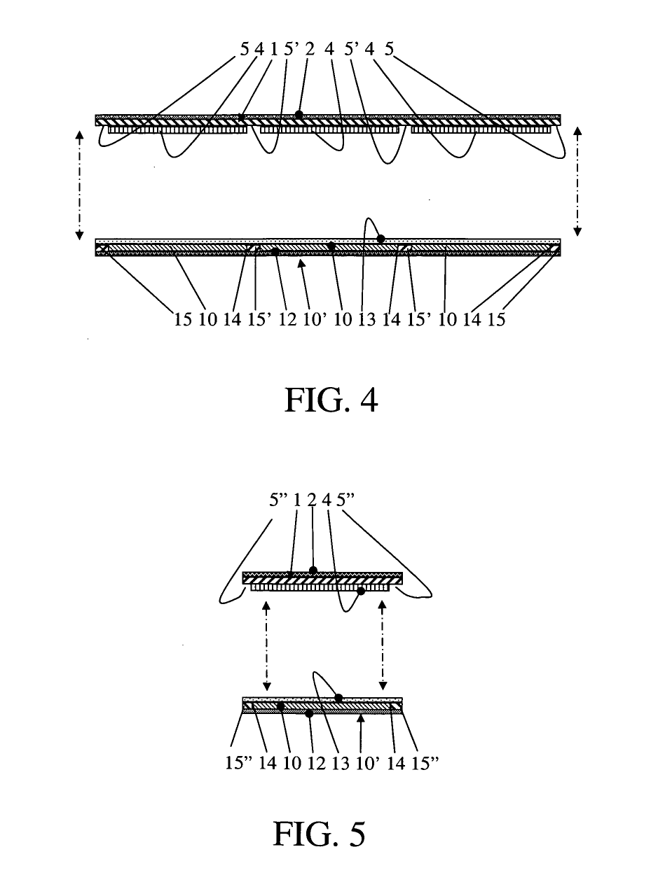

In one embodiment, as shown in FIGS. 1 through 5, the back face of the silicone-coated label body 1 is covered by a paper or self-adhesive plastic body 10′ provided, in the face opposite to that facing the silicone-coated label body 1, with the printing layer 12 configuring the labels themselves 10 and, in the face facing the silicone-coated label body 1, said self-adhesive body 10′ is provided with a pressure-sensitive adhesive layer 13; said self adhesive body 10′ is also provided with cuts 14, which define the shapes of the inner labels 10 and of the bands around them, as follows: two end cross bands 15, defined between the end labels and the cross edges of the self-adhesive body 10′; intermediate cross band(s) 15′, defined between the labels; and two longitudinal bands 15″, defined between the labels and the longitudinal edges of the self-adhesive body 10′; said inner labels 10 are glued so as to be unglued over the respective silicone layer regions 4 of the silicone-coated label body 1 and bands 15, 15′ and 15″ are permanently glued over, respectively, the bands 5, 5′ and 5″ without silicone or with inhibited silicone, arranged around the silicone layer regions 4 of the silicone-coated label body 1.

This label structure is provided with end cross gluing surfaces 3 formed by the outer surfaces of the end cross bands 15 of the self-adhesive body 10′, glued permanently on the end cross bands 5 without silicone or with inhibited silicone of the silicone-coated label body 1. The longitudinal bands 15′ of the self-adhesive body 10′, adhered permanently on the corresponding longitudinal bands 5″ without silicone or with inhibited silicone of the silicone-coated label body 1, are devices to optimize the confinement of the self-adhesive inner labels 10, when the label is applied on the package.

The silicone may be removed by mechanical means, sandpapering or chemical means or, alternatively, said silicone may be inhibited with the application, thereon, of pressure-sensitive adhesive, that is, a silicone by-product (siliconic).

The label structure of this invention may also be provided with a mark 20 in order to actuate in collaboration with a sensor of the usual application equipment.

The label structure according to this invention may be provided in a label tape, which contains a succession of labels and that is supplied as a reel, which labels are cut from the tape at the application time. Optionally, the labels may be supplied already cut, individualized, for the final user.

Detailing the application of the label structure built according to this invention, glue is applied over the end cross gluing surfaces 3 and thereafter the label structure is applied on the receiver package, by gluing one of the ends on it, arranging the label around said package and gluing the opposite end 3 on the first end that was glued over the package.

The label structures are applied by usual applier equipment (not illustrated) of a type able to operate with a label tape, when therefore it comprises mainly the following assemblies: label tape unwinder; of label cutting to separate it from the remaining tape; of label application; and of label application around the receiver package or equipment able to operate with individualized labels, comprised essentially of a magazine for individual supply of the labels and label application stations and label application around the package.

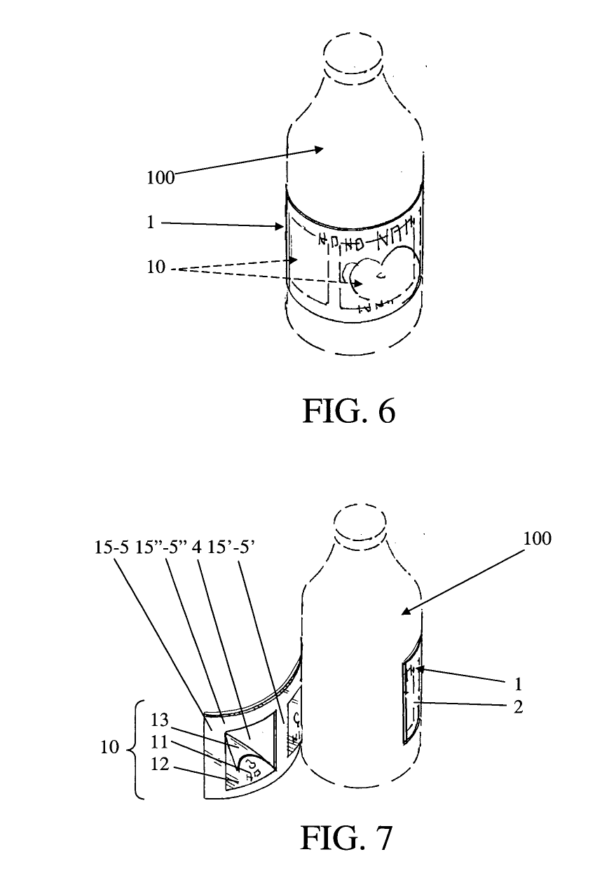

The label structures of this invention, when applied on a package 100 (FIG. 6) have the silicone-coated label body 1 glued on it through the cross end gluing surfaces 3 and with its self-adhesive inner labels 10 containing gifts or coupons or similar products contained between the label body 1, the back longitudinal bands 15″ of the self-adhesive body 10, adhered on the label body 1 and the package surface 100.

For access to the inner labels 10 (FIG. 7), for example, the upper gluing surface 3 is detached from the lower surface 3 and the latter from the package 100 and the inner labels 10 are detached from the silicone layer regions 4 of the back of the label body 1 and said inner labels 10 are glued on any surface, according to the their purpose, through their adhesive layers 13.

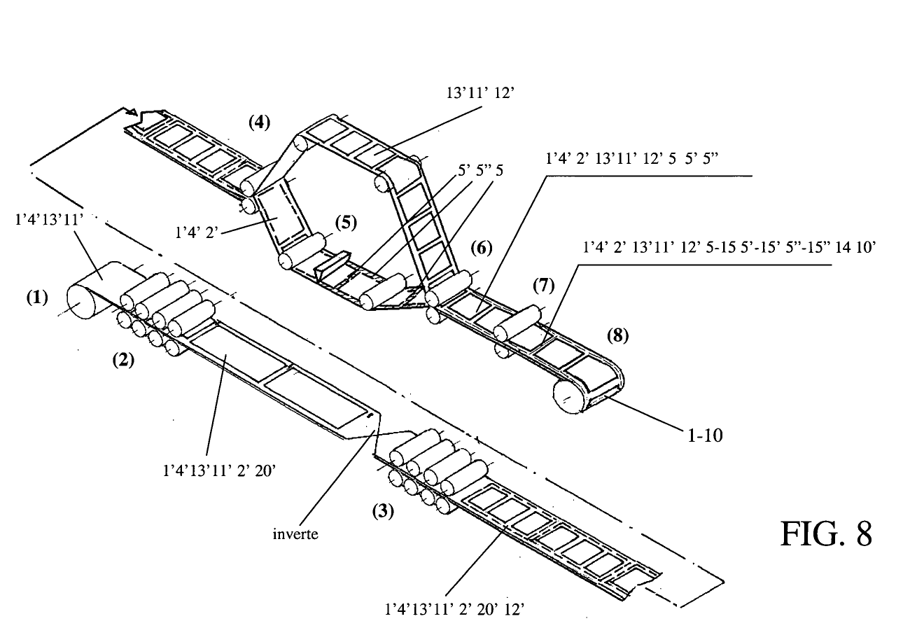

The label structure of this invention is obtained by an obtaining method comprised (FIG. 8) essentially of the following stages:

1) To provide a self-adhesive material tape reel of a type originally used for the obtaining of labels or other self-adhesive products, with proper width and comprised essentially of outer paper or silicone-coated plastic tape 1′;

of an intermediate silicone layer 4′ arranged in the inner face of tape 1′; of an intermediate pressure-sensitive adhesive layer 13′ glued so as to be detached on the silicone layer 4′; and of an outer paper or plastic tape 10″ opposite to the paper or silicone-coated plastic tape 1′, which contains the pressure-sensitive adhesive layer 13′ and unwind said self-adhesive material tape from an unwinder located at the inlet end of the manufacturing equipment, making the traction thereof through a rewinder located at the opposite end of the equipment, so as to cause such tape to pass through the several manufacturing stages;

2) To print on the face of the silicone-coated tape 1′ facing outwards, opposite to that containing the silicone layer 4′, a succession of prints forming the labels themselves 2′, properly spaced from each other and in the intervals between said prints corresponding to one of the label ends, to print the marks 20, which work in collaboration with optical reader in the label application operation;

3) To print on the outer face of the self-adhesive tape 10″, opposite to that containing the adhesive layer 13′, prints at regular intervals forming the inner labels 10 containing gifts or coupons or similar products;

4) To open the self-adhesive material tape in order to separate the silicone-coated tape 1′ from the self-adhesive tape 10″, to uncover its silicone layer 4′;

5) To remove or inhibit the silicone from the cross bands and from the two side longitudinal bands of the silicone layer 4′, of the silicone-coated tape 1′, which will form the back end cross bands 5, intermediate transversal bands 5′ and longitudinal bands 5″, without silicone or with inhibited silicone of the label body 1, which removal or inhibition is made through mechanical medium, sandpapering or application of a proper chemical product for removal or inhibition of the silicone or through application of a pressure-sensitive adhesive that is a silicone by-product (siliconic);

6) To close the self-adhesive material, gluing again the self-adhesive tape 10″ on the silicone-coated tape 1′, so as that the regions corresponding to the inner labels 10 of said self-adhesive tape 10′are glued so as to be detached on the regions of the silicone layer 4 of the silicone-coated tape 1′ and the end cross bands 15, intermediate cross bands 15′ and longitudinal bands 15″ of said self-adhesive tape 10′ glue so as not to be detached, respectively, over the end cross bands 5, intermediate cross bands 5′ and longitudinal bands 5″ without silicone or with inhibited silicone of the silicone-coated tape 1′;

7) To cut 14′ the self-adhesive tape 10″ without cutting the silicone-coated tape 1′ and without extracting the “frame” (bands arising the labels) to define in said self-adhesive tape 10″ the shapes of the self-adhesive inner labels 10 and the end cross bands 15, intermediate cross band 15′ and longitudinal bands 15″, thus forming a tape of labels comprised of a paper or silicone-coated plastic tape 1′, in which front face it is foreseen a printing layer 2′, configuring a succession of labels themselves and, in the back face, there is the forecast of silicone layer regions 4′ and, between said regions 4′ and between them and the cross and longitudinal edges of the label tape, end cross bands 5, intermediate cross bands 5′ and longitudinal bands 5″ without silicone or with inhibited silicone; said label tape being also composed by a self-adhesive back paper or plastic tape 10″ provided, on the surface opposite to that facing the silicone-coated tape 1′, with a printing layer 12′, forming a succession of inner label 10 containing gift or coupon or similar; said self-adhesive tape 10″ being also provided with cuts 14′ that define the shapes of the inner labels 10 and of the cross bands 15 and 15′ and longitudinal bands 15″ arranged around the labels, said self-adhesive tape 10″ being also provided, on the face turned to the silicone-coated tape 1′, with pressure-sensitive adhesive layer 13′, which regions corresponding to inner labels 10 are glued so as to be detached from the silicone regions 4′ and the regions of said adhesive layer 13′ corresponding to the end cross bands 15, intermediate cross band 15′ and longitudinal bands 15″ are permanently adhered on the corresponding end cross bands 5 and intermediate bands 5′ and longitudinal bands 5″ without silicone or with inhibited silicone or the silicone-coated tape 1′, the end cross bands 15 of said self-adhesive tape 10″, permanently adhered on the end cross bands 5 without silicone or with inhibited silicone of the silicone-coated tape 1′, being the gluing surfaces 3 of the label and the longitudinal bands 15″ of said self-adhesive tape 10″, permanently glued on the longitudinal bands 5″ without silicone or with inhibited silicone of the silicone-coated tape 1′ being a device to optimize the confinement of the inner labels 10 when the label is applied on the receiver package; and

8) Finishing comprised of the rewinding of the tape of labels when they are supplied in the form of a label tape or cut of the label tape when they are supplied already cut in the form of individual labels.

The self-adhesive material tape from which the labels are obtained may have width for obtaining of as queue of label or more than one parallel label queues.

The prints 2 comprising the labels themselves and prints 12 of the inner label 10 can be done by any proper printing system, in one or more colors.

Within the basic embodiment described above, the label and method which are the subject of this invention, may present changes related to materials, dimensions, constructive and/or configuration details, functional and/or of decoration, changes of proceeding stages and others, without being out of the scope of the requested protection.

According to this, the body of the inner label 10 containing gift, coupon or similar products may be made from paper or plastic, in this case of BOPP, PVC, polyethylene, polyester or other normally used products. The adhesive comprising the adhesive layer 13 can be any of those normally used in the manufacture of self-adhesive articles, such as hot melt, acrylic and others. The label body 1 may be of paper or plastic with one of its faces covered with silicone (silicone-coated) or others normally used as supporting and protection tape, liner, in self-adhesive articles. The label may be intended to be applied on miscellaneous articles, such as food, cleaning, hygiene and other products. Inner labels 10 may be provided in any proper quantities in each label and, when containing gifts, may be pictures or decals or others that contain any appeal to the consumer of the product containing the label. When the inner labels contain coupons, they may be intended to the participation in a contest of prizes or other promotional campaigns.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A label structure comprising:
a paper or silicone-coated plastic label body (1) provided, on a front surface, with a printing layer (2) and, on a back surface, with a silicone layer and end cross gluing surfaces (3); said label also comprising self-adhesive inner labels (10), formed by a paper or self-adhesive plastic label body (11), having a front surface provided with a printing layer (12) and a back surface provided with a pressure-sensitive adhesive layer (13);
the back surface of the silicone-coated label body (1) being provided with regions of silicone layers (4) arranged in accordance with the self-adhesive inner labels (10) and with bands around said silicone layer regions (4), in which the silicone was removed or inhibited, said bands comprising two end cross bands (5); intermediate cross band(s) (5′); and two longitudinal bands (5″);
the back surface of the silicone-coated label body (1) being covered by a paper or self-adhesive plastic body (10′) provided, on the surface opposite to that facing the silicone-coated label body (1), with the printing layer (12) and on the surface facing the silicone-coated label body (1), with a pressure-sensitive adhesive layer (13);
said self adhesive body (10′) being also provided with cuts (14), which define the shapes of the inner labels (10) and of the bands around them, two end cross bands (15); intermediate cross band(s) (15′) and two longitudinal bands (15″);
said inner labels (10) being glued so as to be unglued over the respective silicone layer regions (4) of the silicone-coated label body (1) and bands (15), (15′) and (15″) of the self-adhesive body (10′) being permanently glued over, respectively, the bands (5), (5′) and (5″) without silicone or with inhibited silicone, arranged around the silicone layer regions (4) of the silicone-coated label body (1).

2. The label structure according to claim 1, wherein the end cross gluing surfaces (3) comprise the outer surfaces of the end cross bands (15) of the self-adhesive body (10′), permanently glued on the end cross bands (5) without silicone or with inhibited silicone of the silicone-coated label body (1).

3. The label structure according to claim 1, wherein the longitudinal bands (15″) of the self-adhesive body (10′), permanently adhered on the corresponding longitudinal bands (5″) without silicone or with inhibited silicone of the silicone-coated label body (1) are devices to optimize the confinement of the self-adhesive inner labels (10), when the label is applied on a package.

4. The label structure according to claim 1, wherein the removal of the silicone is performed by any of mechanical means, sandpapering, chemical means and inhibition with application thereon of silicone by-product pressure-sensitive adhesive (siliconic).

5. A method for obtaining a label structure comprising the steps of:
providing a self-adhesive material tape reel of a type originally used for the obtaining of labels or other self-adhesive products, with a predetermined width and comprising an outer paper or silicone-coated plastic tape (1′); an intermediate silicone layer (4′) arranged in an inner surface of tape (1′); an intermediate pressure-sensitive adhesive layer (13′), glued so as to be detached on the silicone layer (4′); and of an outer paper or plastic tape (10″) opposite to the paper or silicone-coated plastic tape (1′), which contains a pressure-sensitive adhesive layer (13′) and unwind said self-adhesive material tape from an unwinder located at the inlet end of a manufacturing equipment, making the traction thereof through a rewinder located at the opposite end of the equipment, so as to cause such tape to pass through the several manufacturing stages;
printing on the surface of the silicone-coated tape (1′) facing outwards, opposite to that containing the silicone layer (4′), a succession of prints forming labels (2′), properly spaced from each other and in intervals between said prints corresponding to one of the label ends, printing marks (20), which work in collaboration with optical reader in the label application operation;
printing on an outer surface of the self-adhesive tape (10″), opposite to that containing the adhesive layer (13′), prints at regular intervals forming the inner labels (10) containing gifts or coupons or similar products;
opening the self-adhesive material tape in order to separate the silicone-coated tape (1′) from the self-adhesive tape (10″), to uncover its silicone layer (4′);
removing or inhibiting the silicone from the cross bands and from the two side longitudinal bands of the silicone layer (4′), of the silicone-coated tape (1′), which will form the back end cross bands (5), intermediate transversal bands (5′) and longitudinal bands (5″), without silicone or with inhibited silicone of the label body (1);
attaching the self-adhesive material, gluing again the self-adhesive tape (10″) on the silicone-coated tape (1′), so as that the regions corresponding to the inner labels (10) of said self-adhesive tape (10′) are glued so as to be detached on the regions of the silicone layer (4) of the silicone-coated tape (1′) and the end cross bands (15), intermediate cross bands (15′) and longitudinal bands (15″) of said self-adhesive tape (10″) glue so as not to be detached, respectively, over the end cross bands (5), intermediate cross bands (5′) and longitudinal bands (5″) without silicone or with inhibited silicone of the silicone-coated tape (1′);
cutting (14′) the self-adhesive tape (10″) without cutting the silicone-coated tape (1′) and without extracting the “frame” (bands arising the labels) to define in said self-adhesive tape (10″) the shapes of the self-adhesive inner labels (10) and the end cross bands (15), intermediate cross band (15′) and longitudinal bands (15″); and
rewinding the tape of labels when they are supplied in the form of a label tape or cut of the label tape when they are supplied already cut in the form of individual labels.

6. The method according to claim 5, wherein the silicone removal is made through any of mechanical means, sandpapering and application of a proper chemical product of removal or the silicone inhibition is made by the application of silicone by-product pressure-sensitive adhesive (siliconic).
